(19) United States
(12) Patent Application Publication
(10) Pub. No.: US 2007/0262725 A1
(43) Pub. Date: Nov. 15, 2007

(54) Modular Lighting System

(75) Inventor: Paul Koren, Altamonte Springs, FL (US)

Correspondence Address: AKERMAN SENTERFITT, P.O. BOX 3188, WEST PALM BEACH, FL, 33402-3188, US

(73) Assignee: Nexxus Lighting, Inc., Orlando, FL (US)

(21) Appl. No.: 11/759,029

(22) Filed: Jun. 6, 2007

Related U.S. Application Data
(63) Continuation-in-part of application No. 11/066,501, filed on Feb. 25, 2005.
(60) Provisional application No. 60/592,211, filed on Jul. 29, 2004.

(51) Int. Cl. G02B 6/00

(52) U.S. Cl. 315/185 R; 362/340; 362/649; 362/652

(57) ABSTRACT

A modular light system such as for a spa is provided. The light system has a robust coupler with a quick-connect mechanism. The controller can have a single output to provide for daisy-chaining of the lighting components. A lens housing is provided that can accept an LED that is connected to a light harness having a pair of the couplers. The light harness can have any number of LEDs attached thereto and can have an adapter for connection with a main spa light.

### CROSS-REFERENCE TO RELATED APPLICATIONS

This Application is a continuation-in-part of co-pending U.S. application Ser. No. 11/066,501, filed on Feb. 25, 2005, which claims priority to the Provisional Patent Application, U.S. Ser. No. 60/592,211, filed Jul. 29, 2004, the disclosures of which are hereby incorporated by reference.

### BACKGROUND OF THE INVENTION

The present invention relates to light emitting diode (LED) technology, and more particularly to a modular LED lighting assembly and method generally used in spas, saunas or hot tubs.

Manufactured into most spas, saunas and/or hot tubs (hereinafter commonly referred to as “spa” or “spas”) are a plurality of lights. The number of lights integrated into a spa can vary depending on the purpose of the lights and the size of the spa. Typically, lights are used for both providing illumination for safety concerns and for accentuating the spa to provide an enhanced aesthetic appearance.

Currently, spas are either manufactured with wiring for its lighting system encased within insulation that covers an outer surface of a tub in which an individual sits, or the wiring is run on the outside of the insulation. In either case, the wiring is cut to fit around the given tub dimension. Regardless of how the wire is placed around the tub, the wire is usually inaccessible to a user or manufacturer once installed.

In most circumstances, the light, or light emission device, and wire are permanently affixed to each other wherein if either the wire or light fails individually, both must be replaced. If a light, or light emission device, is detached, such as by cutting it, from a wire connecting it to a power source and/or light source, to simply replace the light emission device, not enough wire is typically available to connect the new light emission device to the existing wire because of the precise cut length of the wire. Furthermore, because of the limited access space provided around a tub, especially when the spa is built into the ground, replacing a defective wire can be expensive and time consuming.

In view of the cost and time that results in having to fix a light not emitting from a spa, manufacturers and spa owners would benefit from a system and device which would minimize the repair time and cost involved.

### SUMMARY OF THE INVENTION

The present invention is directed towards a modular light system and method where the primary components, such as but not limited to a light emitter, cable, and controller are readily attachable from the other so that only one of these elements can be replaced if the others are still functioning, or to allow for a lighting system to be installed where one was not presently installed.

Towards this end, in an exemplary embodiment a modular light system for a spa is disclosed where replacement of a light emitter and/or a cable is accomplished without needing access an area around a tub in the spa and replacing the cable and light emitter can be accomplished individually. The modular light system comprises a light emitter with a first attachment element at a first end and a power source. A controller is also provided and is connected to the power source and a second attachment element for connection to the first attachment element of the light emitter. A cable is also provided and has a third attachment element at a first end and a fourth attachment element at a second end for connection the cable to the second attachment element on the controller and the first attachment element on the light emitter. When the light emitter fails, it is disconnected from the cable and replaced with a working light emitter and when and the cable fails it is disconnected from the light emitter and replaced with a working cable.

In another exemplary embodiment, a light system for replacing a light emitter and a cable connected to the light emitter when the cable is not readily accessible is disclosed. The system comprises a light emitter and a controller connected to the light emitter for at least one of providing power to the light emitter and regulating illumination intensity and illumination duration of the light emitter. A power source connected to the controller and a cable connecting the light emitter to the controller are also disclosed. A first connector and/or a first receiver are fixed to each end of the cable. A second connector and/or a second receiver are connected to the light emitter. A third connector and/or a third receiver is connected to the controller. The first connector and/or the first receiver connected to the cable can be connected to and disconnected to the second connector and/or the second receiver connected to the light emitter and can be connected to and disconnected to the third connector and/or the third receiver connected to the controller.

In another exemplary embodiment, a modular light system for a spa is disclosed. The system comprises a controller having a receptacle, a cable, having a first end and a second end with release mechanisms, connected to said receptacle at said a first end of said cable. An adapter having at least a first end into which said second end of said cable attaches and a second end, and a light emitter having a first end that connects to said second end of said adapter are also disclosed.

In another exemplary embodiment, a method for replacing a cable installed within a spa is disclosed. The method comprises the steps of disconnecting both ends of said cable from other parts of said spa and attaching a first end of a coupler to a first end of said cable. Additional steps include attaching a second cable to a second end of said coupler and threading said second cable into a location of said first cable by pulling said first cable from said spa. A couple of other steps are disconnecting said coupler from said second cable and connecting said second cable to said other parts of said spa.

In another exemplary embodiment, a connection system for a lighting system having a controller and a light emitter is disclosed. The connection system comprises at least one cable for transferring at least one of signals and power between the controller and the light emitter; and at least one coupler having first and second ends and an outer surface. The first end has a quick-release mechanism and an adapter. The adapter is connected to the at least one cable for transfer of the at least one of the signals and the power. The at least one coupler has a tapered shape from the second end to a middle portion thereof. The outer surface has at least one flat portion.

In another exemplary embodiment, a lighting system is disclosed comprising a light emitter; a controller configured to provide and regulate power for the light emitter with the controller having a single attachment element; a cable for transferring at least one of signals and power between the controller and the light emitter; and at least one coupler having first and second ends and an outer surface. The first end has a quick-release mechanism and an adapter. The adapter is connected to the cable for transfer of the at least one of the signals and the power. The at least one coupler has a tapered shape from the second end to a middle portion thereof. The outer surface has at least one flat portion.

In another exemplary embodiment, a lighting system connectable to a spa having a spa controller is disclosed. The system comprises a plurality of light emitters; a controller configured to provide and regulate power for each of the plurality of light emitters; a plurality of cables for transferring at least one of signals and power between the controller and the plurality of light emitters; and a plurality of couplers being attached to each of the plurality of cables. Each of the plurality of couplers has first and second ends and an outer surface. The first end has a quick-release mechanism and an adapter. The adapter is connected to the at least one cable for transfer of the at least one of the signals and the power. The controller has at least one attachment element and is operably connectable to a low-voltage output of the spa controller. At least one of the plurality of cables has a different length than another of the plurality of cables.

### BRIEF DESCRIPTION OF THE DRAWINGS

The invention itself, both as to organization and method of operation, may best be understood by reference to the following description in conjunction with the accompanying drawings in which like numbers represent like parts throughout the drawings and in which:

FIG. 1 is an illustration of an exemplary embodiment of a schematic illustrating the present invention;

FIG. 2 is an illustration of an exemplary embodiment of a controller;

FIG. 3 is an illustration of an exemplary embodiment of spa with lights disposed around a spa deck;

FIG. 4 is an illustration of an exemplary embodiment of a spa light further illustrating the present invention;

FIG. 5 is an illustration of an exemplary embodiment of a main spa light further illustrating the present invention;

FIG. 6 is an illustration of an exemplary embodiment of a spa with a cable requiring replacement further illustrating the present invention;

FIG. 7A is an illustration of an exemplary embodiment of a coupler with two male ends;

FIG. 7B is an illustration of an exemplary embodiment of a coupler with two female ends;

FIG. 7C is an illustration of an exemplary embodiment of a coupler with a male and a female end;

FIG. 7D is an illustration of an exemplary embodiment of a coupler with three connection ends;

FIG. 8 is an illustration of an exemplary embodiment of a coupler;

FIG. 8A is an illustration of the connection of a pair of the couplers of FIG. 8;

FIG. 9 is an illustration of an exemplary embodiment of a light harness using the coupler of FIG. 8;

FIG. 9A is an enlarged illustration of the connector of the light harness of FIG. 9;

FIG. 9B is a cross-sectional illustration of the connector of FIG. 9A;

FIG. 10 is an illustration of a jumper cable using the coupler of FIG. 8;

FIG. 11 is an illustration of an exemplary embodiment of a single LED harness;

FIG. 11A is an enlarged illustration of the connectors of the single LED harness of FIG. 11;

FIG. 11B is an enlarged illustration of the joint of the single LED harness of FIG. 11;

FIG. 11C is an enlarged illustration of the LED of the single LED harness of FIG. 11;

FIG. 12 is an illustration of an exemplary embodiment of a multi-LED harness;

FIG. 12A is an enlarged illustration of the LEDs of the multi-LED harness of FIG. 11;

FIG. 13 is an illustration of another exemplary embodiment of a multi-LED harness;

FIG. 14 is an illustration of an exemplary embodiment of a lens housing;

FIG. 14A is an illustration of a top view of the lens housing of FIG. 14;

FIG. 14B is an illustration of a plan view of the lens housing of FIG. 14;

FIG. 14C is an illustration of a cross-sectional view of the lens housing of FIG. 14 with an LED housed therein;

FIG. 15 is an illustration of an exemplary embodiment of a controller;

FIG. 16 is an illustration of an exemplary embodiment of a lighting system; and

FIG. 17 is an illustration of the lighting system of FIG. 16 in a different configuration.

### DETAILED DESCRIPTION OF THE INVENTION

With reference to the figures, exemplary embodiments of the invention will now be described. The scope of the invention disclosed is applicable to a plurality of uses. Thus, even though embodiments are described specifically to spas, the present invention is applicable to other uses or applications where wiring for a light system is run around a hard-to-reach-location such as, but not limited to, a swimming pool.

Additionally, other examples of use of the present invention include uses in the area of architectural lighting such as interior and exterior lighting of residential homes, office complexes and/or other buildings. Similarly, the same or other embodiments may be used in landscaping, such as illuminating sidewalks, pools of water, waterfalls or any other area that needs to be illuminated, including underwater applications.

Furthermore, though the present invention is disclosed specific to LED lights, other forms of lights, such as fiber optic lighting, nano-tubes, surface mount lasers, solid state lasers, semiconductor lasers and electrolumencent diodes and/or tapes, are also applicable to the present invention. Those skilled in the art will readily recognize that a plurality of ways is available to implement the present invention depending on the lighting source used and/or the purpose of the light.

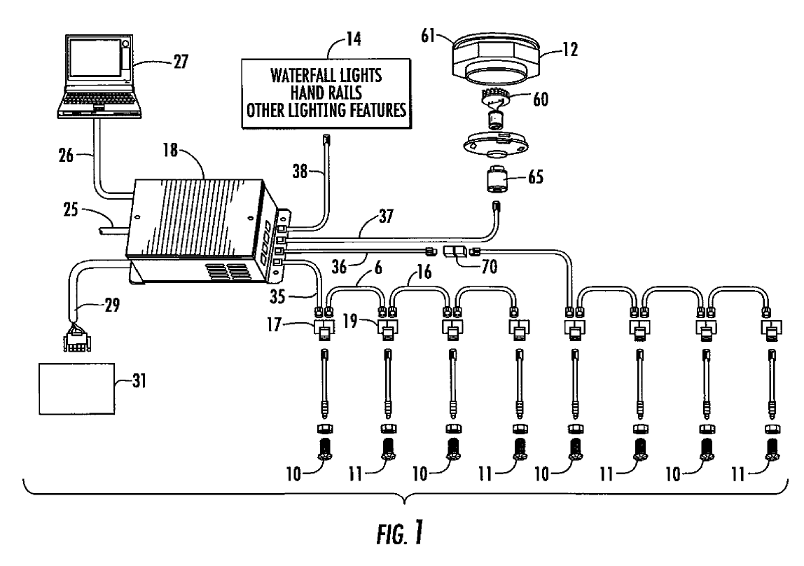

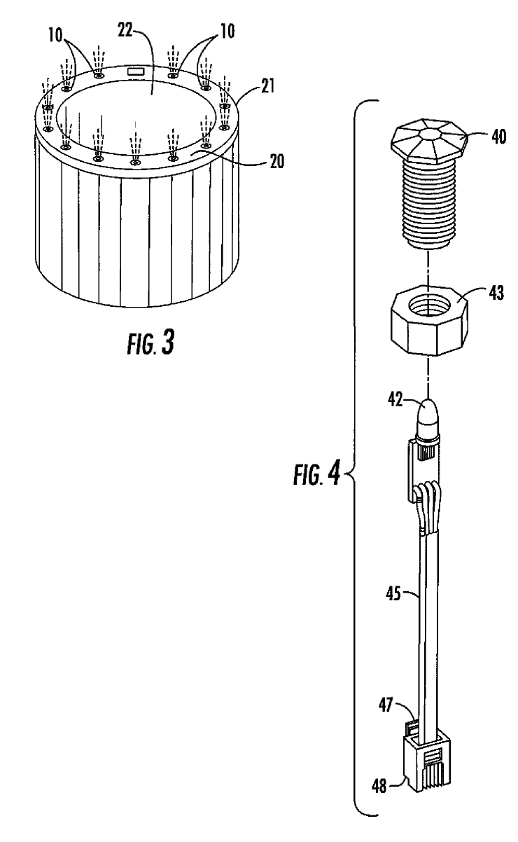

FIG. 1 is an exemplary embodiment of a schematic illustrating the present invention. Though a plurality of different light emitting devices, or light emitter, may be used, as discussed above, a variety of different light-emitting diode (“LED”) fixtures 10, 11, 12, 14 are disclosed as connected to a controller 18. Such LEDs include, but not limited to, a main LED light 12, such as a 12- or 24-LED light, a waterfall feature LED fixture 14, a waterfall light, a pillow light, hand rail, LED candles, lights fixed on or within a speaker (none of which are disclosed), and/or a plurality of single-point LED fixtures 10, 11. As illustrated, in one exemplary embodiment the single-point LED fixtures 10, 11 are daisy-chained together. As illustrated, a connector, line, or cable, 35 leads from the controller 18 into a first adapter 17. A cable 6 extends from the first adapter 17 to a first single-point LED fixture, as further disclosed in FIG. 4-6. From the first adapter 17, a second cable 16 attaches to the first adapter 17 and then to a second adapter 19 and/or directly to a second single-point LED fixture 10, 11.

The individual points of light 10, 11, in one embodiment, are positioned around the deck part 20 of the spa 21, as illustrated in FIG. 3. In another embodiment, the individual points of light 10, 11 are positioned within the tub 23 of the spa 21. A power cable 25 is also connected to the controller 18, as well as a line 26 leading to a programming device 27, such as a computer. A cable 29 is also provided allowing the system to be connected to a music device 31 wherein the lights may be programmed to illuminate at a rate in response to the music.

The programming device 27 can reconfigure the timing sequence of the lights 10, 12, 14, 16 if certain light patterns are desired, such as in beat with music. Pulse width modulation, pulse amplitude modulation, bit angel modulation, pulse position modulation and/or analog control are exemplary techniques that may be employed by a controller to individually or as a group address the LEDs and alternatively turn on, turn off, brighten and/or dim them either individually or in combination as necessary. The controller 18 can, but is not limited to, dim and/or intensify the light, and/or vary the speed of the color change or changing the colors that are emitted from the light or lights. The various color modes include, but are not limited to, color changing mode, party mode, dimming mode and showroom mode (making it dimmer or brighter for showroom display). The controller 18 is able to perform these functions for either a specific light or a specific group of lights.

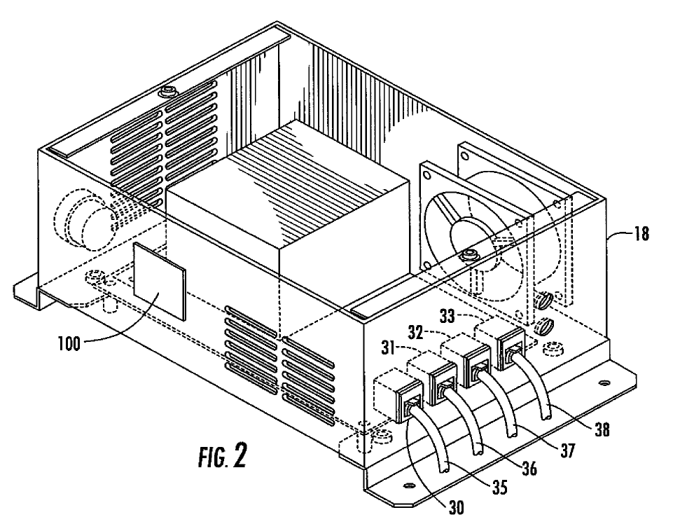

FIG. 2 is an exemplary illustration of a controller 18. As illustrated, outlets, receptacles, connectors, 30, 31, 32, 33 are provided to connect the various light fixtures 10, 12, 14, 16 to the controller 18. These outlets 30, 31, 32, 33 are configured so that the wires connecting the light fixtures 10, 11, 12, 14, controller, and/or music source are readily detachable from the controller 18 instead of being hardwired to the controller. In one embodiment, the outlets 30, 31, 32, 33 are uniform so that a light fixture can be connected to any outlet 30, 31, 32, 33, but ones skilled in the art may employ an approach where each outlet serves a particular purpose.

In one embodiment, a display 100 is provided on the controller 18 where color change and/or color pattern is visible on the controller 18. Thus, within the display LEDs are provided, connected to the same emitters that transmit signals along the cables 35, 36, 37, 38 to illuminate at a rate established by the controller 18. In one embodiment, cables 35, 36, 37, 38 are detachable from both the controller 18 and from the lights 10, 11, 12, 14. Furthermore, the cables 25, 26, 29 leading to the music source, power source, and programmer, may also be detachable from the controller 18 at one end and the respective end source at a second end. Thus, from a manufacturing standpoint, various lengths of cable 35, 36, 37, 38 are manufactured, wherein the user can connect different lengths to the controller 18 which are specific to the user's intended use.

As further illustrated in FIG. 4, a lens 40, such as a star point lens, is provided and is positioned within a deck 20 of the spa 21, as is shown in FIG. 3. A LED 42 fits within and/or beneath the lens 40 and is secured to the lens 40 by an element or elements 43 to secure these components, wherein power and control signals provided to the LED are provided through a cable 45 that connects to the LED at one end. The second end of the cable 45 has a connector 48 that is attachable and detachable from a second power cable 35, 36, 37, 38 and/or an adapter 17, 19.

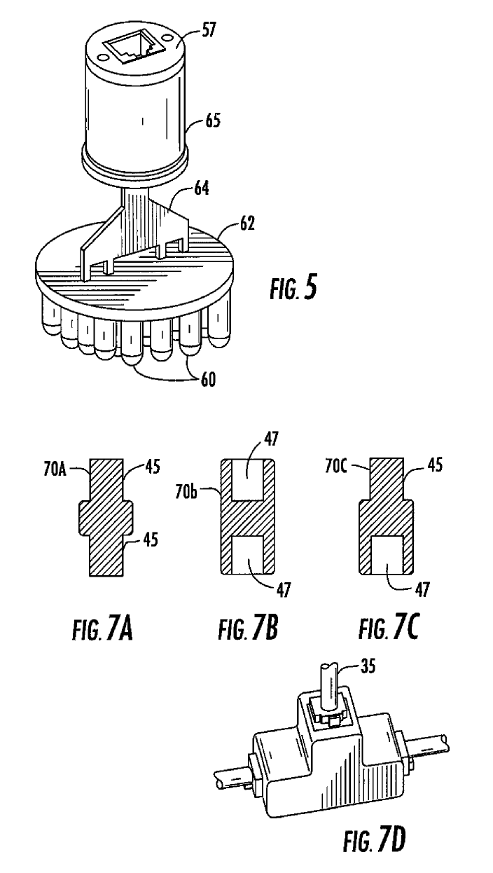

As further illustrated in FIGS. 4, the lens 40 can be opened or disconnected so that the LED 42 is accessible. Once accessible, the LED 42 can be removed, such as when the LED 42 ceases to illuminate. In one embodiment illustrated in FIG. 5, a clip 47, which is part of the end connector 48 is depressed releasing the connector 48 from a receiver cable 35, 36, 37, 38 and/or adapter 17, 19. Thus, in one embodiment, once the lens 40 is removed, enough cable 45 is provided, so that the LED 42 can be easily pulled from the lens component 43 and then disconnected by depressing the detent 47. Those skilled in the art will readily recognize that though a detent is disclosed, other release mechanisms are available wherein activation would release the connector 48 from an element that it is attached to.

As further illustrated in FIGS. 1, 2, and 4, the cable and connectors use phone jack connectors and receivers. As illustrated, the cables and jack connectors are phone cables and jacks where the transfer of data, namely control signals, and power occurs through the phone cables and jacks. With respect to FIG. 4, viewing the connector 45 as a male connector, it fits within a female connector, such as one that is fixed to the second cable 35, 36, 37, 38, located within an adapter 17, and/or directly into the controller 18.

FIG. 5 is an exemplary illustration of a connector that is used with an underwater LED accent light and/or main spa light 12 that comprises a plurality of LEDs 60 within a lens 61. As illustrated, the back of a panel 62 that each LED 60 is connected to has an extension 64 through which and/or on which wires leading to the LEDs 60 are placed. The extension 64 is connected to a joint 65 that has a receiving end 57, illustrated as a female connector, to connect the spa light to a power source and/or signal source 18, through cables 6, 35, 36, 37, 38, having a male connector, which provides power and/or a signal to the LEDs 60.

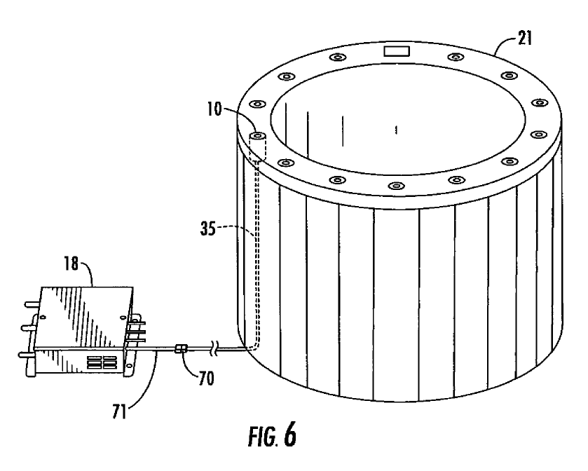

Within a spa 20, the controller 18 is usually positioned at a location where it is accessible by a user. Thus, all cables 35, 36, 37, 38 leading from the controller 18 are usually accessible at the controller 18. However, the pathways for the cables 35, 36, 37, 38 connected to the controller 18 and leading to light emitters 10, 11, 12, 14 are usually not accessible. As illustrated in FIG. 6, if a cable between a light emitter 10 and the controller 18 must be removed, a user must first disconnect each end of the cable 35 from the controller 18 and the light emitter 10. Once disconnected, a coupler, joiner element, or joiner, 70 is connected to either end of the cable 35 and a new cable 71 is then connected to the other end of the joiner 70. The coupler 70 can be configured a plurality of ways.

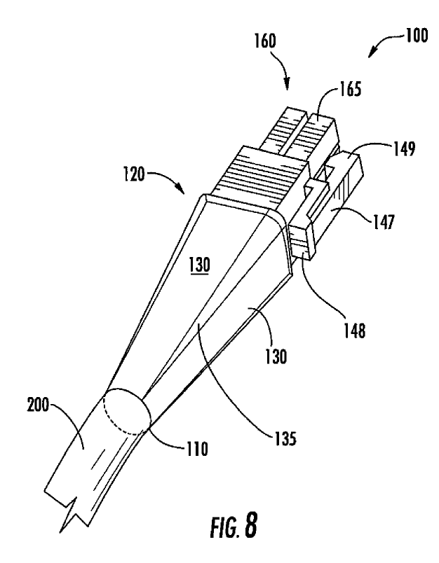

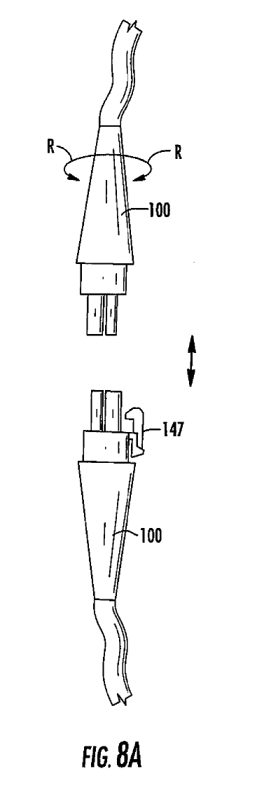

As illustrated in FIGS. 7a, 7b, and 7c, the coupler 70 can have two male ends 70a, two female ends 70b, or a male and a female end 70c. Thus, if the cable 35 being removed has male ends 45, the joiner 70b with two female ends 47 is used where a first end of the joiner 70b is connected to one end of the cable 35, such as the end that is connected to the controller 18. At the second end of the cable 35, a replacement cable 71 is connected. In one embodiment, the joiner 70a, 70b, 70c has a diameter nearly as small as the cable 35 being removed. Thus, a user can then pull the old cable 35 out, which in turn pulls the new cable 71 into place.

As further illustrated in FIG. 1, the coupler is also used to connect cables together when shorter cables are used in place of a longer single cable. In another exemplary embodiment, the coupler has more than two connection ends, such as three, as illustrated in FIG. 7d, four, or more, to allow either lights or additional cables to be connected at a single joint.

In another embodiment, though not illustrated, the present invention can be used to provide a lighting system to older spas that were manufactured without a lighting system. A hole-forming device, such as a drill, can be used to create holes in the spa, either along the deck or directly into the spa, through which light emitters 10, 11 are placed. As disclosed above, the coupler(s) 17, 19 can be used to thread wires, or cables 6, 35, 36, 37, 38 from the controller 18 to the light source 10, 11, 12, 14, and/or music source.

Referring to FIG. 8, a coupler is shown and generally represented by reference numeral 100. The coupler 100 can be used with cable, conduit or other wiring, and facilitates removable connection of various components of a lighting system, such as the system shown in FIG. 1. Coupler 100 has a quick connect mechanism, such as a detent 147, to allow for assembly and disassembly without the need for any tools.

Detent 147 is a biased lug that can be depressed at a first end 148 to remove the lug 149 from its connection or engagement position. However, the present disclosure contemplates the use of other quick connect mechanisms, as well as other attachment mechanisms to provide for connection and disconnection. In another embodiment, coupler 100 can have a pair of detents 147 that are diametrically opposed to provide for a more robust connection. The particular number of detents 147 can be chosen based upon the desired connection, as well as other factors including the particular environment of the coupler. The use of more than one detent 147 can provide for a secure connection even if one of the detents becomes damaged or otherwise fails.

Coupler 100 has a tapered shape from a first end 1 10 to a middle portion 120. Preferably, the outer surface of the coupler 100 has one or more flat surfaces 130 and preferably has diametrically opposed flat surfaces to facilitate gripping of the coupler during the connection and disconnection process. In the exemplary embodiment of FIG. 8, coupler 100 has four diametrically opposed flat surfaces 130 having chamfered edges 135 therebetween so that the coupler can easily be grasped at any orientation.

End 160 of the coupler 100 has an adapter 165 or the like to provide for a robust electrical and/or communicative coupling of the coupler to another component, such as the controller 18 of FIG. 1. End 110 of the coupler 100 has a cable, conduit or other wiring 200 for communication with other components of the lighting system, such as the components shown in the system of FIG. 1. It should be understood that the particular type of cable, conduit or other wiring 200, as well as the type of adapter 165, can be chosen based upon the type of transfer occurring, e.g., data, signals, and/or power being supplied therethrough. Adapter 165 can be a male, a female or a combination of male and female connectors.

Referring to FIG. 8A, coupler 100 can be used for connection with a second coupler (with its detent hidden in this view). The second coupler 100 can be rotated 90 degrees as shown by arrows R so that the couplers can be connected for transfer of power and/or signals therethrough. Other components of the lighting system, such as the controller, can have a second coupler 100 hardwired to the component for configuring the lighting system.

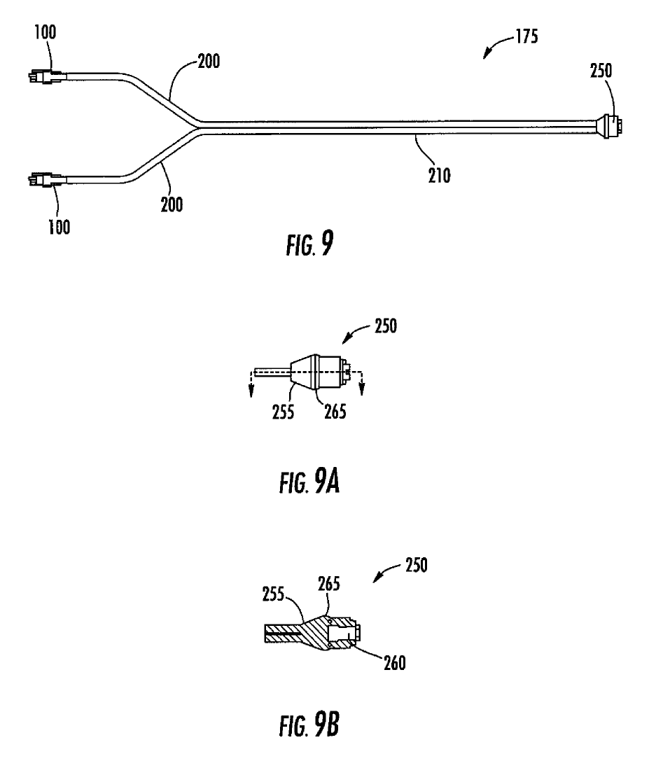

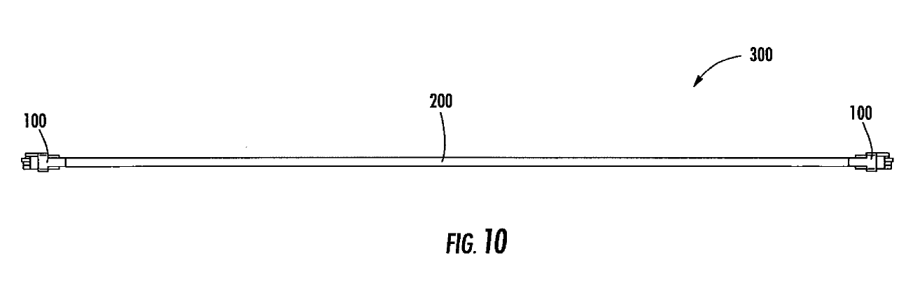

Referring to FIGS. 1 and 9-9B, a light harness is shown and generally represented by reference numeral 175. Light harness 175 can be used with the main spa light 12 of FIG. 1, although the present disclosure contemplates using the harness with other components. To facilitate coupling of the components of the system of FIG. 1, as well as to provide flexibility and additional modularity to the system, harness 175 has first and second couplers 100 and cables 200 connected to a connector 250. The harness 175 provides for a daisy-chained configuration so that additional components can be connected to the harness 175, rather than requiring connection back to the controller 18. Harness 175 can have a sheath 210 or the like to maintain a portion of the cables 200 together to facilitate handling, as well as positioning, of the harness. In one embodiment, harness 175 can maintain a portion of the cables 200 together by a frangible connection so that the cables 200 can be separated as required for positioning with respect to the components of the system of FIG. 1.

Connector 250 is removably connectable with extension 64 of LED 60 of the main spa light 12 (FIG. 5) via female connection 260. However, the present disclosure contemplates the use of other connection structure and methods for the connector 250. Preferably, connector 250 has a tapered shape from a proximate end 255 to a middle portion 265. The shape of the connector 250 allows for a more robust device that is less likely to be damaged or fail because of a harsh environment.

Referring to FIG. 10, a jumper cable is shown and generally represented by reference numeral 300. Jumper cable 300 has first and second ends with couplers 100 and a cable 200 therebetween. Jumper cable 300 provides additional flexibility and modularity to the system of FIG. 1. For example, the jumper cable 300 can be used as an extension between the harness 175 and the controller 18 or other components of the system of FIG. 1. The particular length of the jumper cable 300 can vary. In one embodiment, a kit is provided with a plurality of jumper cables 300. The jumper cables 300 can be used individually or connected together to achieve desired lengths. The kit provides further flexibility and modularity for the system of FIG. 1 by facilitating positioning of various components at any desired location through use of one or more of the jumper cables 300 without the need for custom-sized cables.

In another embodiment, a kit is provided with a plurality of jumper cables 300 having differing lengths. The jumper cables 300 can be used individually or connected together to achieve desired lengths. The kit provides further flexibility and modularity for the system of FIG. 1 by facilitating positioning of various components at any desired location through use of one or more of the jumper cables 300 without the need for custom-sized cables.

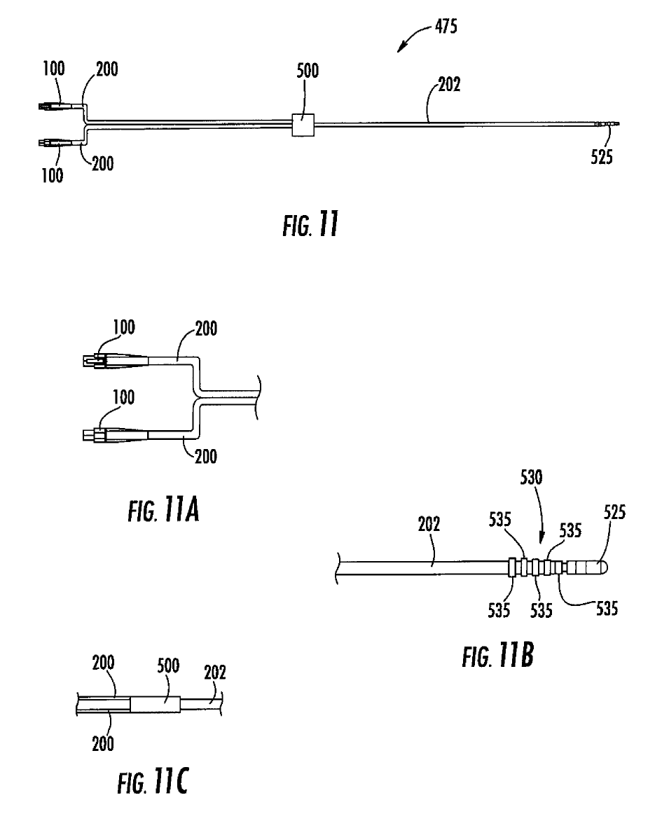

Referring to FIGS. 11-11C, a single LED harness is shown and generally represented by reference numeral 475. LED harness 475 can be used with a lens or the like, such as lens 40 of the system of FIG. 1. To facilitate coupling of the components of the system of FIG. 1, as well as to provide flexibility and additional modularity to the system, harness 475 has first and second couplers 100 and cables 200 connected to a junction 500. The harness 475 provides for a daisy-chained configuration so that additional components can be connected to the harness 475, rather than requiring connection back to the controller 18.

Harness 475 can have a sheath or the like to maintain a portion of the cables 200 together to facilitate handling, as well as positioning, of the harness. In one embodiment, harness 475 can maintain a portion of the cables 200 together by a frangible connection so that the cables 200 can be separated as required for positioning with respect to the components of the system of FIG. 1. Junction 500 couples the cables 200 to a second cable 202 that is in communication with an LED 525 at a distal end thereof.

The distal end of cable 202 has a connector 530 positioned in proximity to the LED 525. In one embodiment, connector 530 is a series of bands 535 having increasing diameters in a direction away from the LED 525. The bands 535 can be connected to a lens or the like for securing the LED 525 in position. However, the present disclosure contemplates the use of other connection structure and methods for the connector 530.

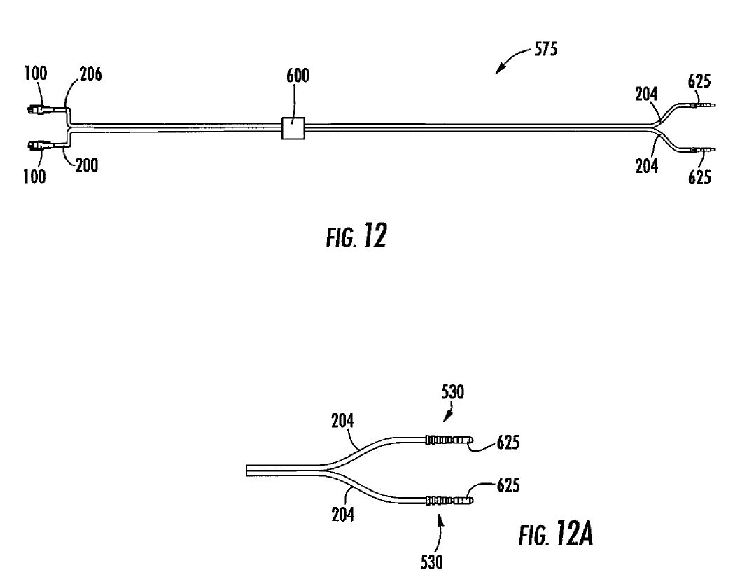

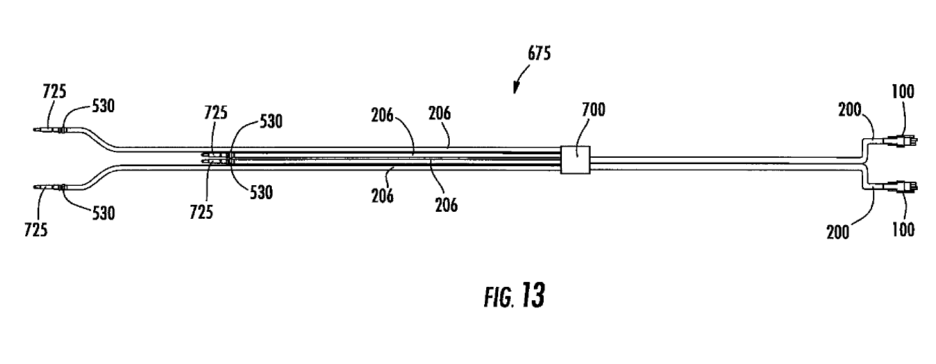

Referring to FIGS. 12-12A, a double LED harness is shown and generally represented by reference numeral 575. LED harness 575 can be used with a plurality of lenses or the like, such as lens 40 of the system of FIG. 1. To facilitate coupling of the components of the system of FIG. 1, as well as to provide flexibility and additional modularity to the system, harness 575 has first and second couplers 100 and cables 200 connected to a junction 600. The harness 575 provides for a daisy-chained configuration so that additional components can be connected to the harness 575, rather than requiring connection back to the controller 18.

Harness 575 can have a sheath or the like to maintain a portion of the cables 200 together to facilitate handling, as well as positioning, of the harness. In one embodiment, harness 575 can maintain a portion of the cables 200 together by a frangible connection so that the cables 200 can be separated as required for positioning with respect to the components of the system of FIG. 1.

Junction 600 couples the cables 200 to a pair of second cables 204 that are each in communication with an LED 625 at a distal end thereof. Harness 575 can have a sheath or the like to maintain a portion of the cables 204 together to facilitate handling, as well as positioning, of the harness. In one embodiment, harness 575 can maintain a portion of the cables 204 together by a frangible connection so that the cables 204 can be separated as required for positioning with respect to the lenses or the like of the system of FIG. 1. The distal end of each of the cables 204 can have the connector 530 positioned in proximity to the LEDs 625. The present disclosure contemplates the use of various connection structures and methods for the connector 530.

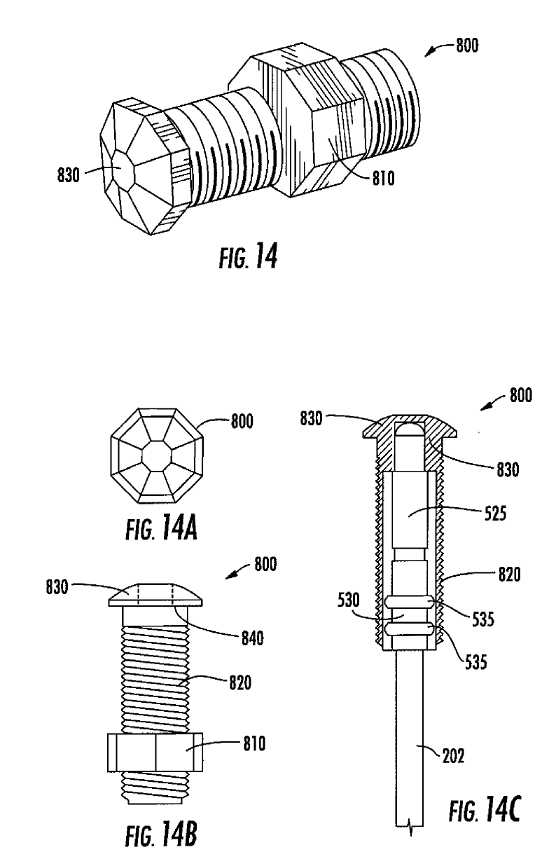

Referring to FIG. 13, a quadruple LED harness is shown and generally represented by reference numeral 675. LED harness 675 can be used with a plurality of lenses or the like, such as lens 40 of the system of FIG. 1. To facilitate coupling of the components of the system of FIG. 1, as well as to provide flexibility and additional modularity to the system, harness 675 has first and second couplers 100 and cables 200 connected to a junction 700. The harness 675 provides for a daisy-chained configuration so that additional components can be connected to the harness 675, rather than requiring connection back to the controller 18.

Harness 675 can have a sheath or the like to maintain a portion of the cables 200 together to facilitate handling, as well as positioning, of the harness. In one embodiment, harness 675 can maintain a portion of the cables 200 together by a frangible connection so that the cables 200 can be separated as required for positioning with respect to the components of the system of FIG. 1.

Junction 700 couples the cables 200 to four additional cables 206 that are each in communication with an LED 725 at a distal end thereof. It should be understood that the present disclosure also contemplates the use of other numbers of cables 206 and LEDs 725. The cables 206 can have different lengths. In one embodiment, a first pair of cables 206 has a first length and a second pair of the cables has a second length, as shown in FIG. 13. The particular lengths and configurations can be chosen based on a number of factors including the desired positioning of the LEDs 725 in the system of FIG. 1, as well as the desired level of flexibility and modularity. For example, a large number of cables 206 and LEDs 725 can be used with each of the successive cables having a larger size than the previous cable.

Harness 675 can have a sheath or the like to maintain a portion of the cables 206 together to facilitate handling, as well as positioning, of the harness. In one embodiment, harness 675 can maintain a portion of the cables 206 together by a frangible connection so that one or more of the cables 206 can be separated from the other cables as required for positioning with respect to the lenses or the like of the system of FIG. 1. The distal end of each of the cables 206 can have the connector 530 positioned in proximity to the LEDs 725. The present disclosure contemplates the use of various connection structures and methods for the connector 530.

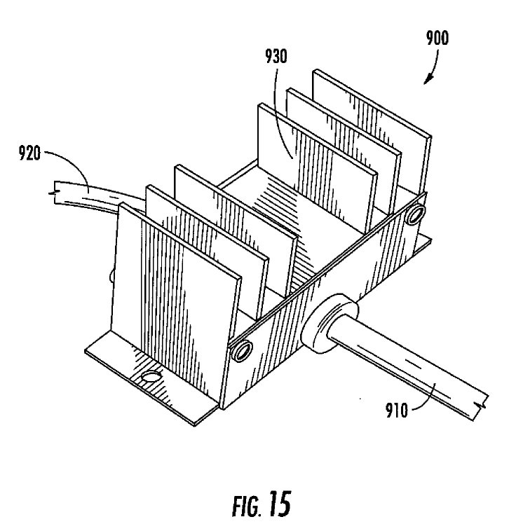

Referring to FIGS. 14-14C, a lens housing is shown and generally represented by reference numeral 800. Lens housing 800 can accept an LED, such as one of LEDs 525, 625, or 725. The lens housing 800 can be installed into an orifice or the like, such as in a deck of a spa, through use of securing bolt 810 and threads 820. However, the present disclosure contemplates the use of other securing structures and techniques, such as a ratchet connection mechanism. The lens housing 800 is transparent and preferably made from plastic.

Lens housing 800 has a lens head 830 with a lower flat surface 840 that facilitates installment of the lens housing into a flat surface. Preferably, the connector 530 with bands 535 are over-molded onto the LED 525 and cable 202. The material used for the connector 530 and/or bands 535 can be resilient to facilitate positioning of the LED in the lens housing 800, and to allow for a compression fit therein. The bands 535 hold the LED 525 within the lens housing 800, while also maintaining a strong seal against water penetration.

Referring to FIG. 15, a controller that can control any one of LEDs 525, 625, 725 is shown and generally represented by reference numeral 900. Controller 900 can be a low voltage LED controller connectable to a 12V light output on a standard portable spa controller via a cable 920. The controller 900 can have a single output for daisy-chaining LED lights and/or underwater spa lights. In one embodiment, controller 900 allows for color selection, including color changing mode, by toggling of the power on/off switch. One or more heat fins 930 can be attached to or formed on the controller 900 for dissipation of heat.

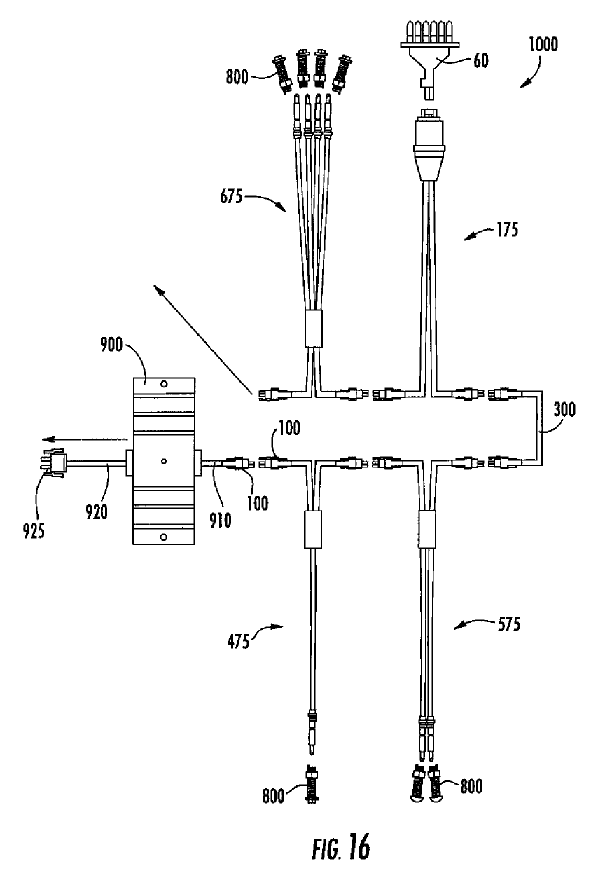

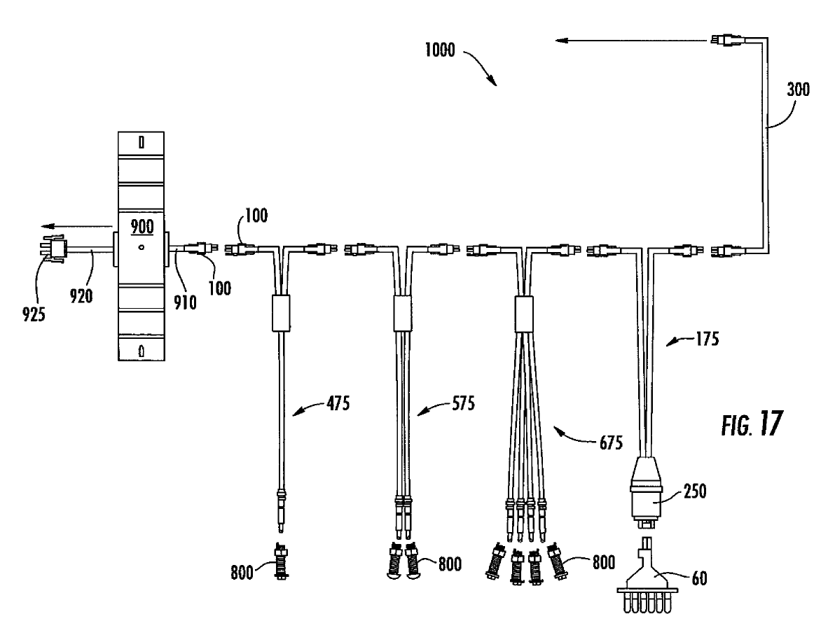

Referring to FIG. 16, a lighting system is shown and generally represented by reference numeral 1000. Lighting system 1000 has a controller 900 connectable to the low voltage or 1 2V output of a spa controller. The controller 900 has a single output cable 910 with a connector 100 that allows for daisy chaining of multiple components of the lighting system 1000, such as light harnesses 475, 575 and 675. A jumper cable 300 is used to include the harness 175 with main spa light 60. The use of daisy-chaining of the components facilitates assembly and requires less material since there is no need to run separate cables back to the controller 900.

Referring to FIG. 17, the lighting system 1000 is shown in a second configuration. The same components as in FIG. 16 have now been positioned in a different configuration through use of the daisy-chaining technique. As described above, the use of daisy-chaining of the components facilitates assembly and requires less material since there is no need to run separate cables back to the controller 900. It should be understood that the present disclosure contemplates controller 900 or another controller having multiple outputs that may or may not utilize the daisy-chaining technique for configuring the lighting system

While the invention has been described in what is presently considered to be a preferred embodiment, many variations and modifications will become apparent to those skilled in the art. Accordingly, it is intended that the invention not be limited to the specific illustrative embodiment, but be interpreted within the full spirit and scope of the appended claims.

What is claimed is:

1. A connection system for a lighting system having a controller and a light emitter, the connection system comprising:
at least one cable for transferring at least one of signals and power between the controller and the light emitter; and
at least one coupler having first and second ends and an outer surface, the first end having a quick-release mechanism and an adapter, the adapter being connected to the at least one cable for transfer of the at least one of the signals and the power, wherein the at least one coupler has a tapered shape from the second end to a middle portion thereof, and wherein the outer surface has at least one flat portion.

2. The system of claim 1, wherein the at least one flat portion is a plurality of flat portions, and wherein pairs of the plurality of flat portions are diametrically opposed along the outer surface.

3. The system of claim 2, wherein the at least one coupler has chamfered edges between each of the plurality of flat portions.

4. The system of claim 1, wherein the quick-release mechanism is a biased lug.

5. The system of claim 1, wherein the light emitter is an LED, wherein the at least one coupler is positioned at a first cable end of the at least one cable, wherein the LED is over-molded onto a second cable end of the at least one cable, and wherein the at least one cable communicates the at least one of the signals and the power to the LED.

6. The system of claim 1, wherein the light emitter is an LED, wherein the at least one coupler is a plurality of couplers, wherein the at least one cable is a plurality of cables, wherein each of the plurality of couplers are positioned at a first cable end of the plurality of cables, wherein the LED is over-molded onto a second cable end of the plurality of cables, and wherein one of the plurality of cables communicates the at least one of the signals and the power to the LED.

7. The system of claim 1, wherein the light emitter is a plurality of LEDs, wherein the at least one coupler is a plurality of couplers, wherein the at least one cable is a plurality of cables, wherein each of the plurality of couplers are positioned at a first cable end of the plurality of cables, wherein each of the plurality of LEDs is over-molded onto a second cable end of each of the plurality of cables, and wherein the plurality of cables communicates the at least one of the signals and the power to the plurality of LEDs.

8. A lighting system comprising:
a light emitter;
a controller configured to provide and regulate power for the light emitter, the controller having a single attachment element;
a cable for transferring at least one of signals and power between the controller and the light emitter; and
at least one coupler having first and second ends and an outer surface, the first end having a quick-release mechanism and an adapter, the adapter being connected to the cable for transfer of the at least one of the signals and the power, wherein the at least one coupler has a tapered shape from the second end to a middle portion thereof, and wherein the outer surface has at least one flat portion.

9. The system of claim 8, wherein the at least one flat portion is a plurality of flat portions, and wherein pairs of the plurality of flat portions are diametrically opposed along the outer surface.

10. The system of claim 9, wherein the at least one coupler has chamfered edges between each of the plurality of flat portions.

11. The system of claim 8, wherein the quick-release mechanism is a biased lug.

12. The system of claim 8, wherein the light emitter is an LED, wherein the at least one coupler is positioned at a first cable end of the cable, wherein the LED is positioned at a second cable end of the cable, and wherein the cable communicates the at least one of the signals and the power to the LED.

13. The system of claim 8, wherein the light emitter is an LED, wherein the at least one coupler is a plurality of couplers, wherein the cable is a plurality of cables, wherein each of the plurality of couplers are positioned at a first cable end of the plurality of cables, wherein the LED is positioned at a second cable end of the plurality of cables, and wherein one of the plurality of cables communicates the at least one of the signals and the power to the LED.

14. The system of claim 8, wherein the light emitter is a plurality of LEDs, wherein the at least one coupler is a plurality of couplers, wherein the cable is a plurality of cables, wherein each of the plurality of couplers are positioned at a first cable end of the plurality of cables, wherein each of the plurality of LEDs is positioned at a second cable end of the plurality of cables, and wherein the plurality of cables communicates the at least one of the signals and the power to the plurality of LEDs.

15. A lighting system connectable to a spa having a spa controller, the system comprising:
a plurality of light emitters;
a controller configured to provide and regulate power for each of the plurality of light emitters, the controller having at least one attachment element and being operably connectable to a low-voltage output of the spa controller;
a plurality of cables for transferring at least one of signals and power between the controller and the plurality of light emitters, wherein at least one of the plurality of cables has a different length than another of the plurality of cables; and
a plurality of couplers being attached to each of the plurality of cables, each of the plurality of couplers having first and second ends and an outer surface, the first end having a quick-release mechanism and an adapter, the adapter being connected to the at least one cable for transfer of the at least one of the signals and the power.

16. The system of claim 15, wherein the plurality of couplers each have a tapered shape from the second end to a middle portion thereof, and wherein the outer surface has at least one flat portion.

17. The system of claim 16, wherein the at least one flat portion is a plurality of flat portions, and wherein pairs of the plurality of flat portions are diametrically opposed along the outer surface.

18. The system of claim 15, wherein the quick-release mechanism is a biased lug.

19. The system of claim 15, wherein at least one of the plurality of light emitters is an LED, wherein each of the plurality of couplers is positioned at a first cable end of the plurality of cables, wherein the LED is positioned at a second cable end of one of the plurality of cables, and wherein at lest one of the plurality of cables communicates the at least one of the signals and the power to the LED.

20. The system of claim 15, wherein the controller has a single output and each of the plurality of light emitters is daisy-chained together.
